(19) United States
(12) Patent Application Publication
(10) Pub. No.: US 2013/0206079 A1
(43) Pub. Date: Aug. 15, 2013

(54) Cat Scratcher With Encapsulated Grit Layer

(71) Applicants: John M. Lipscomb, Cedarburg, WI (US); Jonathan D. Supanich, Fox Point, WI (US)

(72) Inventors: John M. Lipscomb, Cedarburg, WI (US); Jonathan D. Supanich, Fox Point, WI (US)

(73) Assignee: Pioneer Pet Products LLC, Cedarburg, WI (US)

(21) Appl. No.: 13/821,106

(22) PCT Filed: Jun. 8, 2012
(86) PCT No.: PCT/US12/41653

§ 371 Date: Apr. 22, 2013

Related U.S. Application Data
(60) Provisional application No. 61/495,108, filed on Jun. 9, 2011.

(51) Int. Cl. A01K 15/02

(52) U.S. Cl. CPC A01K 15/024
USPC 119/706

(57) ABSTRACT

A cat scratcher that includes encapsulated cat claw abrading grit layers that can dull claws of a cat using the cat scratcher and which are interleaved throughout a scratching block of the cat scratcher. The encapsulated grit layer may define a self-contained unit in which grit particles are encapsulated between a pair of backing sheets so that substantially none of the grit particles are exposed or visible. The encapsulated grit layer may include a sandpaper strip that has a sandpaper backing sheet and grit particles that are bonded to the sandpaper backing sheet and define a gritty surface of the sandpaper strip that faces away from the sandpaper backing sheet. A seal sheet may engage the gritty surface of the sandpaper strip so that the gritty particles are wholly sandwiched and sealed between the sandpaper backing and seal sheets.

### FIELD

The present invention relates generally to devices that are configured for cats to scratch, e.g., cat scratchers, and more particularly to improved cat scratchers that can dull the claws of a cat while the cat uses the cat scratcher.

### BACKGROUND

Cat scratchers are popular for allowing a cat to use its claws on the scratcher instead of, for example, household furniture. Cat scratcher manufacturers have tried to configure their cat scratchers in order to dull the claws of a cat while the cat uses the scratcher. To achieve this, the cat scratcher manufacturers have provided cat scratchers with cardboard strips that are stacked edgewise and abut each other. Sand is glued to an upper surface of these cat scratchers to provide a claw-dulling abrasive upper surface.

### SUMMARY

The present inventors have recognized that although the known cat scratchers are at least somewhat suitable for their intended purposes, improvements to claw-dulling cat scratchers may be desirable. The present inventors have recognized that gluing sand to cardboard provides an adhesive force between the sand and cardboard that can be overcome by (i) claws that pick or rip through the cardboard, and (ii) jostling or bending of the cat scratcher during shipping or even moving the cat scratcher within the pet owner's residence, which dislodges the sand from their glued attachment to the cardboard and creates a messy pile of free sand particles near the cat scratcher. The inventors have further recognized that because the sand particles can be dislodged in this manner, known cat scratchers rapidly lose their claw-dulling capacity before the cardboard has been fully used up or scratched apart by the cat and that further use of the cat scratchers may actually sharpen the claws of the cat instead of dulling the claws. The inventors have further recognized that cleaning up the pile or accumulation of free sand particles near the cat scratcher can be more difficult and take substantially more time than is required to clean up the relatively large pieces of cardboard that are torn away from the cat scratcher during use, whereby the amount of cleanup time for cat scratchers tends to be intimately related to how many of the sand particles have been dislodged from the cat scratcher. The inventors have also recognized that known corrugated cat scratchers have cardboard layers that extend parallel to a longitudinal axis of the cat scratchers and that cats may claw parallel to such cardboard layers which may reduce a likelihood of the claws engaging sand particles that are arranged parallel to the cardboard layers since the claws may tend to advance between the sand particle arrangements and through undulating corrugated sheets of the cardboard layers that may be relatively easier to tear than other cardboard components, such as linerboards, which may relatively reduce the use-life of the cat scratcher. The present invention contemplates a cat scratcher that addresses these and/or other inventor-identified problems and drawbacks of the prior art.

In accordance with an aspect of the invention, a cat scratcher is provided with at least one encapsulated grit layer that abrades claws of a cat during scratching the cat scratcher. The cat scratcher may include a scratching block and the encapsulated claw abrading grit layer may be wholly self-contained and then laminated or otherwise attached to other components of the scratching block so as to incorporate the encapsulated grit layer into the cat scratcher. This may provide claw-dulling materials substantially without particles that can dislodge from the cat scratcher. In a preferred embodiment, the cat scratcher includes a plurality of spaced apart encapsulated claw abrading grit layers and can include a plurality of pairs, i.e., at least three, of such grit layers.

In accordance with another aspect of the invention, the encapsulated grit layer may be provided edgewise with respect to the scratching block, so that the encapsulated grit layer appears line-like from a top plan view above an exposed scratching surface of the scratching block and may extend along the depth of or downwardly into the scratching block. A first encapsulated grit layer may extend depth-wise into the scratching block and in a longitudinal and/or transverse direction(s) with respect to the scratching block. This advantageously provides claw-dulling throughout substantially the entire depth of the scratching block and can do so without presenting a claw-dulling continuous surface in a plane that is parallel to the scratching surface which could be engaged by relatively delicate soft paw pads of a cat using the cat scratcher.

In accordance with another aspect of the invention, the encapsulated claw-abrading grit layer includes a backing sheet and grit particles that are bonded to the backing sheet. A second backing sheet is provided over the gritty surface of the encapsulated grit layer so that the grit particles are sandwiched between the backing sheets trapping them therebetween.

In accordance with another aspect of the invention, the encapsulated grit layer may include a sandpaper strip that has a sandpaper backing sheet that defines one backing sheet of the encapsulated grit layer. A seal sheet may be provided over a gritty surface of the sandpaper to define a second backing sheet of the encapsulated grit layer so that the grit particles are fully contained and bonded and/or sealed between (i) the sandpaper backing sheet or first backing sheet and (ii) the seal sheet or second backing sheet. In another preferred encapsulated grit layer, the grit layer is formed of a pair of sandpaper strips that have opposed gritty surfaces that engage each other and backing sheets that face outwardly away from each other and with respect to the encapsulated grit layer. The backing sheets may be made from a non-cardboard material, for example, at least one of paper, cloth, and a polymeric film that can provide a substrate for the grit particles to be bonded. This may provide claw-dulling grit particles that remain sealed within an encapsulated grit layer during use.

In accordance with another aspect of the invention, the scratching block of the cat scratcher includes columns of cardboard and the encapsulated grit layer(s) may be provided between adjacent pairs of the columns of cardboard. The first and second backing sheets may provide barriers between the grit particles and the columns of cardboard. This may provide an encapsulated grit layer(s) that is wholly self-contained between non-cardboard barriers so that claw-dulling grit particles of the encapsulated grit layer remain substantially sealed within the encapsulated grit layer, during use.

In accordance with another aspect of the invention, the backing sheet(s) to which the grit particles are bonded requires less force to tear than the amount of force required to dislodge the grit particles from the backing sheet(s). The encapsulated grit layer may have a tear strength that is defined by a force required for tearing through the backing and/or seal sheets. Such tear strength may be larger than a grit bonding strength that is defined by a force required to dislodge grit particles from the backing or seal sheet to which the grit particles are bonded. This may allow the encapsulated grit layer to tear in preference to grit particle being dislodged from the encapsulated grit layer which may allow the scratching block to wear or be used up during use by the ripping or tearing of relatively large sheet-like pieces from the scratching block, which may be easier to clean up and preferable for other reasons when compared to an accumulation of dusty and granular dislodged sand particles. This advantageously also prevents grit particles from inadvertently being dislodged as they are trapped between backing layers.

In accordance with another aspect of the invention, a cat scratcher is provided that includes encapsulated cat claw abrading grit layers that can dull claws of a cat using the cat scratcher and which are interleaved throughout a scratching block of the cat scratcher. The encapsulated grit layer may include a sandpaper strip that has a sandpaper backing sheet and grit particles that are bonded to the sandpaper backing sheet and define a gritty surface of the sandpaper strip that faces away from the sandpaper backing sheet. A seal sheet may engage the gritty surface of the sandpaper strip so that the gritty particles are wholly sandwiched and sealed between the sandpaper backing and seal sheets. It may be more difficult for grit particles to be dislodged from the encapsulated grit layer than it is to tear through the encapsulated grit layer, whereby mechanical agitation such as clawing or scratching from a cat using the cat scratcher will remove chunks of encapsulated grit layer by tearing of chunks, with the grit particles remaining encapsulated or sealed with respect to such removed chunks, in preference to the grit particles being dislodged therefrom. The encapsulated grit layer therefore wears out or is used up by piecewise tearing removal of chunks from the encapsulated grit layer substantially without accumulation of granular dislodged particulate matter.

### DRAWING DESCRIPTION

Preferred exemplary embodiments of the invention are illustrated in the accompanying drawings in which like reference numerals represent like parts throughout and in which:

FIG. 1 is an orthogonal view of a cat scratcher in accordance with the present invention.

FIG. 2 is an orthogonal view of a variant of the cat scratcher of FIG. 1.

FIG. 3 is an exploded orthogonal view of a portion of a scratching block of the cat scratcher of FIG. 1.

FIG. 4 is an exploded top plan view of a portion of a scratching block of the cat scratcher of FIG. 1.

FIG. 5 is a top plan view of the portion of the scratching block of FIG. 4.

FIG. 6 is an exploded top plan view of a portion of a variant of the scratching block of FIG. 4.

FIG. 7 is an exploded top plan view of a portion of another variant of the scratching block of FIG. 4.

FIG. 8 is an exploded top plan view of a portion of another variant of the scratching block of FIG. 4.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

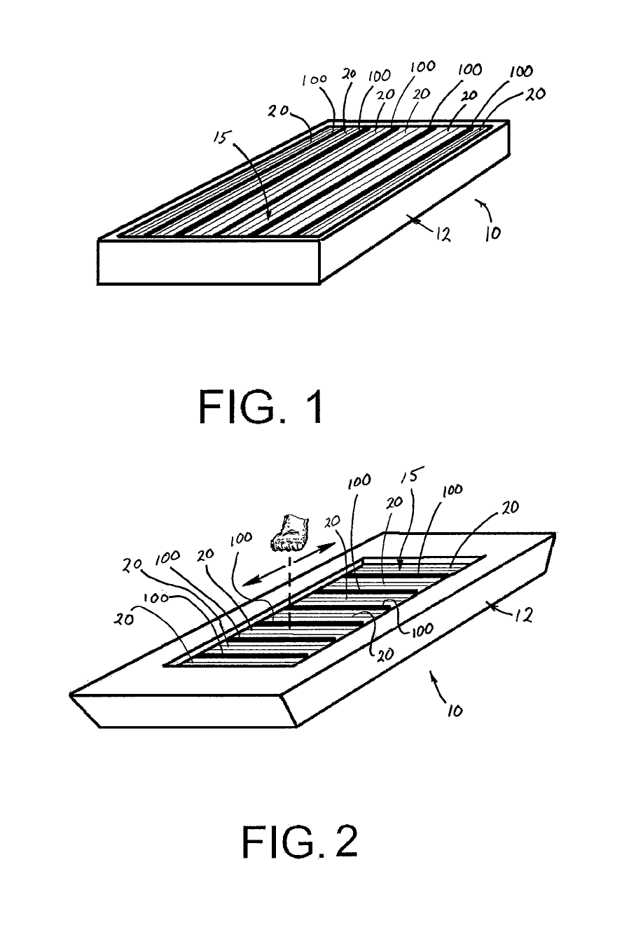

With reference to FIG. 1, the present invention is directed to a cat scratcher 10 that can dull the claws of a cat using the cat scratcher 10 and that produces relatively little dust or small amounts of particulate waste product during use. Cat scratcher 10 includes a housing 12 and a scratching block 15 that is held within the housing 12. Scratching block 15, in this illustrated embodiment, includes multiple cardboard columns 20 and self-contained units of encapsulated grit layers 100 between adjacent pairs of the cardboard columns 20.

In one embodiment, the encapsulated grit layers 100 are transversely spaced from each other and interleaved throughout the scratching block 15 so that adjacent encapsulated grit layers 100 are spaced less than about two inches, optionally less than about one inch or less than about one-half inch, from each other. Such spacing helps ensure that the claws of a cat scratching the scratching block 15 come into contact with at least one encapsulated grit layer during scratching. Although the cardboard columns 20 and encapsulated grit layers 100 are shown in FIG. 1 as all extending in a common direction, in some embodiments, some of the cardboard columns 20 and encapsulated grit layers 100 may extend in different directions, for example, transversely with respect to other ones of the cardboard columns 20 and encapsulated grit layers 100 so that different encapsulated grit layers 100 face different directions which may provide yet other locations within the scratching block 15 in which claws can be dulled.

With reference now to FIG. 2, in this preferred embodiment, all of the cardboard columns 20 are arranged transversely with respect to a longitudinal axis of the scratcher 10. In this embodiment, the housing 12 is made from a readily disposable and/recyclable material, such as cardboard. The housing 12 is preferable made from a single blank of cardboard or other suitable material that is folded about the edges or corners at points of intersection between the interconnected walls of the finally-assembled housing 12, to arrive at an enclosure with an internal cavity that is accessible through an opening in one of the interconnected walls. Housing 12 of this embodiment has a pair of substantially parallel side walls and slanted front and back walls that extend from a top wall, angularly inward, toward a bottom wall. The top wall includes a relatively large opening that exposes a majority of an upper surface area of the scratching block 15 that is held within the cavity of the housing 12. The opening of the top wall of the housing 12 defines an area that is preferably at least about 75-percent of the surface area of the scratching block 15. With the cardboard columns 20 being accessible through the opening of the housing top wall and arranged transversely with respect to the longitudinal axis of the scratcher 10, the encapsulated grit layers 100 are arranged transversely with respect to a scratching direction(s), illustrated by the arrows that point toward the front and back of the scratcher 10, thus in directions parallel to the longitudinal axis of the scratcher 10. This helps ensure that when a cat pulls its claws through the scratching block 15, along a clawing stroke travel distance that is greater than a distance between adjacent encapsulated grit layers 100, the claws will encounter at least two encapsulated grit layers 100 during the clawing stroke. When a cat pulls its claws through the scratching block 15 along a claw strokes travel distance that is substantially the same as the distance between adjacent encapsulated grit layers 100, the claws will encounter at least one encapsulated grit layer 100 during the clawing stroke.

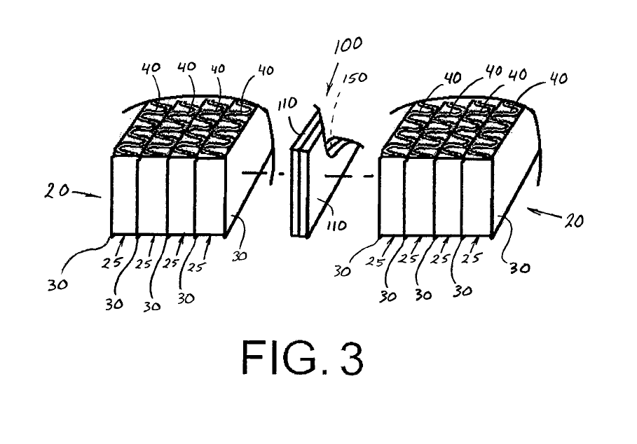

With reference now to FIG. 3, in this embodiment, the cardboard columns 20 include multiple adjoined cardboard layers 25. Each cardboard layer 25 includes a pair of linerboards 30 that are made from cardboard materials and a fluted corrugated sheet 40 that is made from cardboard materials and that extends transversely between and connects the linerboards 30 in an undulating manner, with apexes of the undulations being connected to the linerboards 30. In this embodiment, adjacent corrugated sheets 40 share a single, common, linerboard 30 between them. In one preferred embodiment, each of the cardboard columns 20 has a rectangular cross-section, with a height of the cross-section that is about 75 percent to about 85 percent of a width of the cross-section. In one embodiment, the cardboard column 20 has a cross-sectional height of about 1.25 inches and a cross-sectional width of about 1.50 inches. The length of each of the cardboard columns 20 and the particular number of cardboard columns 20 that are provided adjacent each other within the scratching block 15 are selected based on predetermined desired overall dimensions for the scratching block 15.

Still referring to FIG. 3, in this embodiment, each of the encapsulated grit layers 100 defines a strip-like layer that is arranged upright or on edge. Arranging the encapsulated grit layers 100 in this way provides each with a width or thickness that is less than its height or depth, with respect to the scratching block 15. In one preferred embodiment, the grit layers 100 extend entirely through the depth of the scratching block 15 so that a height of the encapsulated grit layer 100 is substantially the same as, for example, within about plus or minus 5-percent of, the cross-sectional height of the cardboard columns 20. As illustrated in FIG. 1, in this embodiment, the lengths of the encapsulated grit layers 100 are substantially the same as, for example, within about plus or minus 5-percent of, the lengths of the cardboard columns 20.

Referring again to FIG. 3 in this embodiment, each of the encapsulated grit layers 100 is wholly self-contained and then adhered, laminated, or otherwise attached to the adjacent cardboard columns 20 to arrive at the interleaved layout of the encapsulated grit layers 100 within the scratching block 15 (FIG. 1). Each encapsulated grit layer 100 includes at least one backing sheet 110, two being shown, and grit particles 150 that are fully bonded to the backing sheet 110 which gives the encapsulated grit layer 100 a unitized configuration that can be interleaved within the scratching block 15 with the grit particles 150 being sealed within the encapsulated grit layer 100 and away or distinct from the cardboard columns 20. Each encapsulated grit layer 100 thus defines a self-contained unit in which there are no or substantially no exposed grit particles 150.

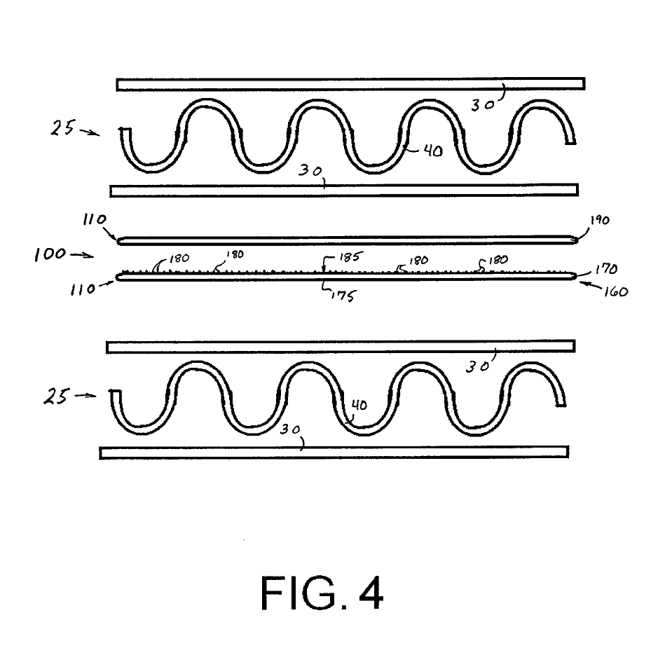

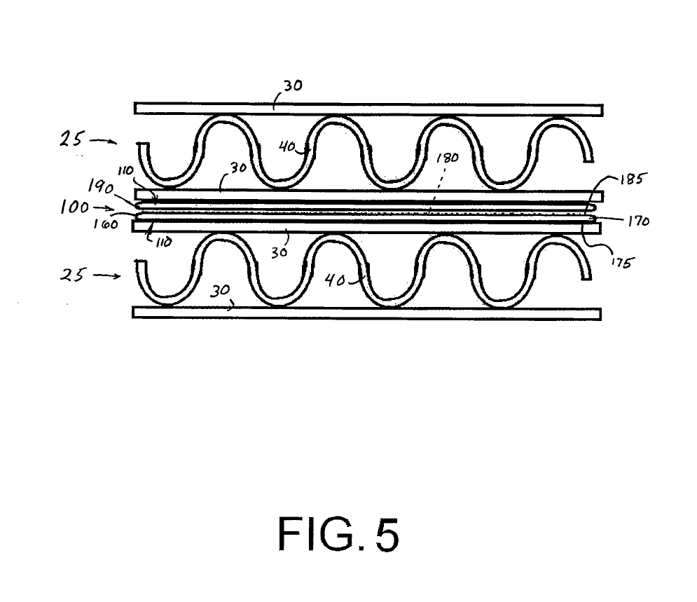

With reference now to FIGS. 4 and 5, in this embodiment, an encapsulated grit layer 100 is shown having grit particles 180 are sealed and encapsulated between a pair of backing sheets 110. In a preferred embodiment, the backing sheets 110 are made from non-cardboard materials. Exemplary suitable non-cardboard materials for use as backing sheets 110 include paper materials, cloth materials, and polymeric film materials. In a preferred embodiment, the grit particles 180 have grit sizes of between about 80 and 150, for example about 120, according to a CAMI (Coated Abrasive Manufacturers Institute) standard. Each grit layer 100 has a plurality of pairs, i.e., at least three grit particles 180 made of almandite, e.g., red garnet, aluminum oxide, silicon carbide, or another grit material used in sandpaper.

Still referring to FIGS. 4 and 5, the encapsulated grit layer 100 of this embodiment includes a sandpaper strip 160. The sandpaper strip 160 includes a sandpaper backing sheet 170 made from paper, cloth, and/or polymeric film material(s) and grit particles 180 that are bonded to the sandpaper backing sheet 170 and define a gritty surface 185 and an opposing non-gritty surface 175 of the sandpaper strip 160. In one embodiment, the sandpaper strip 160 is a sheet of commercially available sandpaper of between 80 and 150 grit. In one preferred embodiment, the sandpaper strip 160 is a sheet of 120 grit sandpaper having a sandpaper backing sheet 170 made of paper with the grit particles 180 bonded to the paper backing sheet 170 using an adhesive, such as a glue, resin, lamination, or the like. The sheet of sandpaper can by nine inches by twelve inches or can be a strip of narrower or wider sandpaper unrolled from a roll during making of a scratching block 15.

In such a preferred embodiment, the sandpaper backing sheet 170 defines a first one of the pair of backing sheets 110 and a seal sheet 190 that is provided over the gritty surface 185 defines a second one of the pair of backing sheets 110 that sandwich and seal the grit particles 180 therebetween. The seal sheet 190 is preferably bonded to the entire gritty surface 185, although in some embodiments, the seal sheet 190 is adhered or otherwise joined to the gritty surface 185 at a joinder location or at multiple discrete locations that are spaced from each other. After bonding, the seal sheet 190 completely covers the gritty surface 185 thereby holding the grit particles 180 in place during use and operation of the scratcher. Regardless of the particular way in which the seal sheet 190 is joined to the gritty surface 185, the grit particles 180 are sealed within the encapsulated grit layer 100 so that the grit particles 180 remain contained within the encapsulated grit layer 100 during use, so that the grit particles 180 are substantially unable to be dislodged from their encapsulation within the grit layer 100. This allows the encapsulated grit layer 100 to define a self-contained unit in which there are no or substantially no exposed grit particles 180.

In one method of making a scratching block 15 of a scratcher 10 (FIG. 1), the seal sheet 190 is unrolled from a roll and is bonded to the gritty surface 185 of the sandpaper strip 160 using an adhesive, such as a glue or resin. The sandpaper strip 160 is also unrolled from a roll with the grit particles 180 of its gritty surface 185 facing toward the roll of the seal sheet 190 being unrolled with application of adhesive prior to or as they are being brought together in contact with one another. Such an encapsulated grit layer 100 can then be attached using an adhesive, e.g., a glue or resin, to a linerboard 30 of a layer 25 of cardboard during manufacture of the cardboard layer 25. In a preferred embodiment, each grit layer 100 is sandwiched or laminated between a plurality of cardboard layers 25 with the grit layer 100 alternating between a pair cardboard layers 25 or between a pair of cardboard columns 20 that are each made of a plurality of cardboard layers 25 as depicted in FIG. 2. Since the grit particles 180 are encapsulated between backing sheets 110 with there being no visible exposed surface of grit particles 180, the grit particles 180 not only are better retained during shipment and use but being held captive during cat scratching advantageously increases cat claw abrading effectiveness.

With reference now to FIGS. 1, 2, and 3, in a preferred method of making a scratching block 15 of a scratcher 10, the entire scratching block 15 is made during a cardboard making process in which the cardboard columns 20 are produced. In this way, the scratching block 15 can be entirely assembled at a single manufacturing facility, such as a paper converting facility, at which the cardboard columns 20 are produced. At the paper converting facility, a converting machine(s) converts suitable feedstock into the linerboards 30 and fluted corrugated sheets 40 and a corrugating machine and/or other suitable machine(s) align and glue the alternating fluted corrugated sheets 40 and linerboards 30 to each other to assemble the cardboard columns 20. The encapsulated grit layers 100 are assembled, for example, by adhering and/or bonding the seal sheets 190 to the gritty surfaces 185 of the sandpaper strips 160 and the encapsulated grit layers 100 are adhered or bonded between adjacent cardboard columns 20. This is done by applying a suitable adhesive(s) and/or a bonding agent(s) between the components of the encapsulated grit layers 100 and also between the encapsulated grit layers 100 and the cardboard columns 20, as described above in greater detail, to arrive at the entire assemblage of scratching block 15. The adhesive(s) and/or bonding agent(s) of the newly assembled scratching blocks 15 are allowed to cure, which may include passing the scratching blocks 15 over steam heated plates or through a curing station, depending on the particular adhesive(s) and/or bonding agent(s) that is used for assembling the scratching blocks 15.

Referring again to FIGS. 4 and 5, in this preferred embodiment, it is easier to tear through the sandpaper backing and seal sheets 170, 190 than it is to dislodge the grit particles 180 from the encapsulated grit layer 100. Accordingly, the encapsulated grit layer 100 has a tear strength that is defined by the amount of force required to tear the sandpaper backing and seal sheets 170, 190, and the sandpaper strip 160 has a grit bonding strength that is defined by an amount of force required to dislodge grit particles 180 from the sandpaper backing sheet 170. The grit bonding strength is greater than the encapsulated grit layer tear strength, whereby the encapsulated grit layer 100 tears before the grit particles 180 can be dislodged from the sandpaper backing sheet 170. This allows the grit particles 180 to remain encapsulated within and sealed between pieces of sandpaper backing and seal sheets 170, 190 that are torn from the remainder of the encapsulated grit layer 100 during use. In this way, the encapsulated grit layer 100 wears out or is used up by being torn and removed in sheet-like chunks of sandpaper backing and seal sheets 170, 190 with the grit particles 180 remaining encapsulated or sealed thereto, instead of having individual grit particles 180 being removed therefrom.

In one embodiment, the tear strength and grit bonding strengths of the encapsulated grit layer 100 are defined with respect to a single backing sheet 110, whether a single or a pair of backing sheets 110 are incorporated into the encapsulated grit layer 100. For example, with continued reference to FIGS. 4 and 5, the tear strength of the encapsulated grit layer 100 may be defined as an amount of force required to tear the sandpaper backing sheet 170 and the grit bonding strength may be defined as an amount of force required to dislodge the grit particles 180 from the sandpaper backing sheet 170. During use of such embodiment, the sandpaper strip 160 may piecewise tear into chunks of backing sheet 170 with the embedded or sealed grit particles 180 remaining bonded to the chunks of backing sheet 170, without the grit particles 180 being dislodged therefrom, even though the seal sheet 190 may separate at least partially from the sandpaper strip 160. This allows the backing sheet 170 to tear and/or the grit particles 180 to dull in preference to releasing grit particles 180 from the bonded attachment of the grit particles with the backing sheet 170.

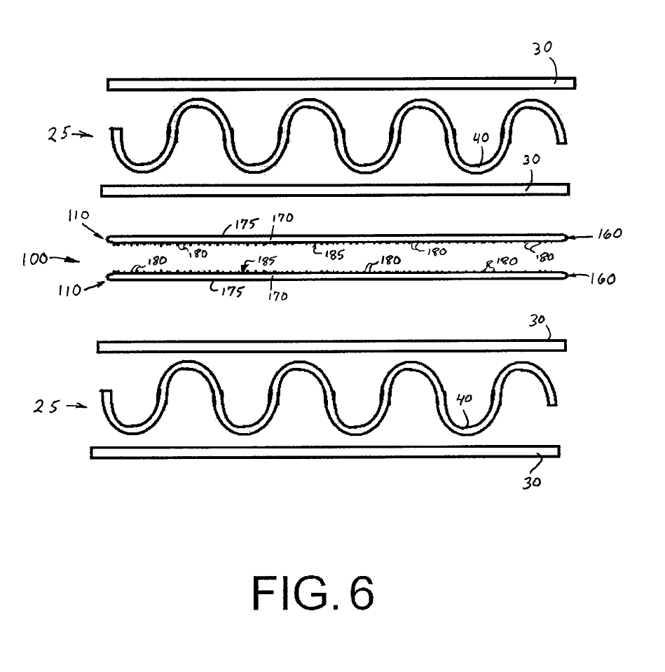

Referring now to FIG. 6, in this embodiment, the encapsulated grit layer 100 includes a pair of sandpaper strips 160. The sandpaper strips 160 are positioned so that their gritty surfaces 185 engage each other and their non-gritty surfaces 175 engage respective cardboard columns 20. Similar to the seal sheet 190 discussed above, the gritty surfaces 185 of the sandpaper strips 160 can be adhered or otherwise joined to each other at a joinder location or at multiple discrete locations that are spaced from each other. In this embodiment also, the encapsulated grit layer 100 can sacrificially tear before the grit particles 180 can be removed from the sandpaper strips 160 to ensure that substantially no grit particles 180 are released from the encapsulated grit layer 100 during use.

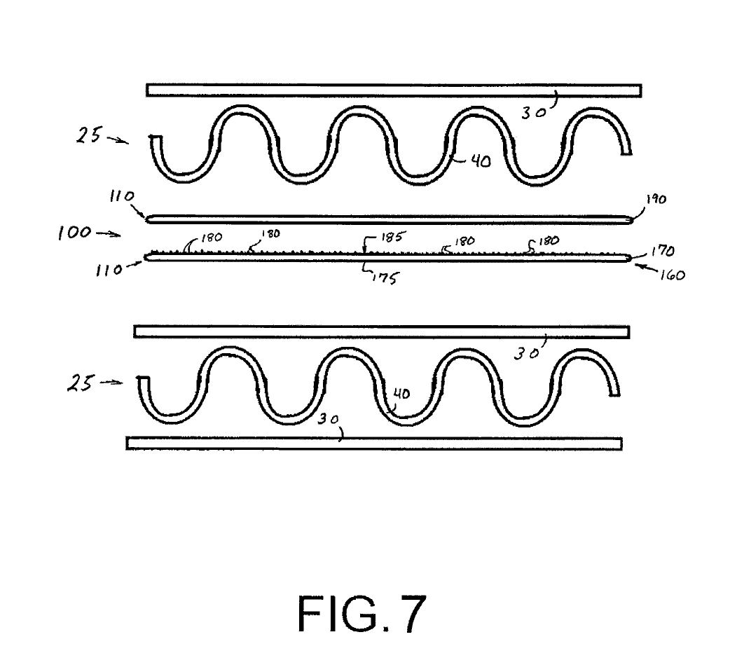

Referring now to FIG. 7, this embodiment, the encapsulated grit layer 100 is substantially the same at that shown in FIGS. 4 and 5, whereby the description of the encapsulated grit layer 100 of FIGS. 4 and 5 is applicable here with respect to FIG. 7. However, the encapsulated layer 100 of FIG. 7 does not have both a seal sheet 190 as a second backing sheet 110 and liner board 30 that engages a fluted corrugated sheet 40 as shown in FIGS. 4 and 5. Instead, the encapsulated layer 100 of FIG. 7 includes a seal sheet 190 as a second backing sheet 110 that includes an outwardly directed surface 192 that faces away from the grit particles 180 that the seal sheet 190 encapsulates and that also engages and directly supports the fluted corrugated sheet 40. This may be achieved by adhering or otherwise securing the respective apexes of the curves of the fluted corrugated sheet 40 to the outwardly directed surface 192 of the seal sheet 190 at spaced apart locations upon the seal sheet 190 that correspond to the discrete locations of engagement of between the apexes of the curves of the fluted corrugated sheet 40 and the outwardly directed surface 192 of the seal sheet 190. Accordingly, the seal sheet 190 of this embodiment may serve the functions of both a grit 180 encapsulating backing sheet 110 and a fluted corrugated sheet 40 supporting linerboard 30. The seal sheet 190 may be made from the same paper, cloth, or polymeric film material(s) as the sandpaper backing sheet 170, or the seal sheet 190 may be made from a cardboard material which may be the same cardboard material as the linerboards 30 within the cardboard layers 25.

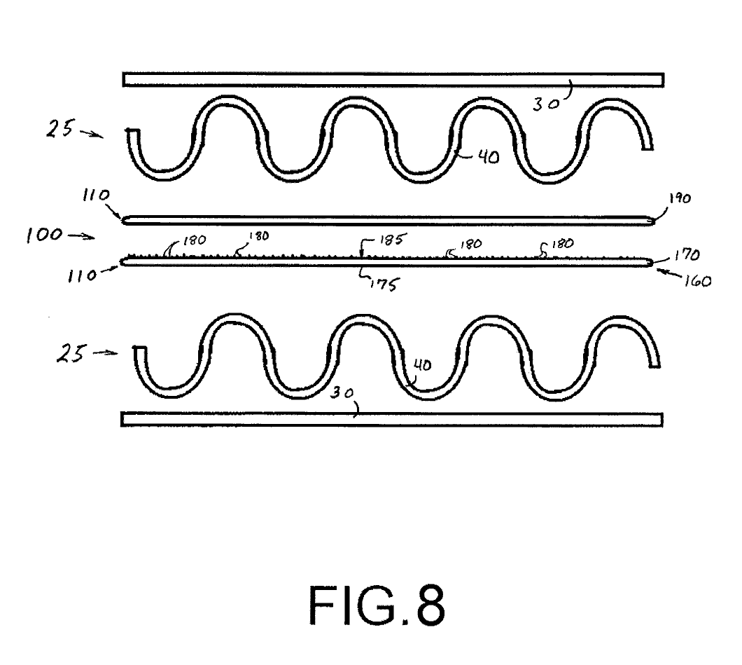

Referring now to FIG. 8, the encapsulated grit layer 100 is substantially the same at that shown in FIGS. 4 and 5, whereby the description of the encapsulated grit layer 100 of FIGS. 4 and 5 is applicable here with respect to FIG. 8. The encapsulated grit layer 100 of FIG. 8 is similar to that of FIG. 7 in that the outwardly directed surface 192 of the seal sheet 190 directly engages the apexes of the fluted corrugated sheet 40. Accordingly, the seal sheet 190 of FIG. 8 may also serve the functions of both a grit 180 encapsulating backing sheet 110 and a fluted corrugated sheet 40 supporting linerboard 30. There is also no liner board 30 (FIG. 4) between the backing sheet 170 and an adjacent fluted corrugated sheet 40. Accordingly, the non-gritty surface 175 of the backing sheet 170 directly supports the respective fluted corrugated sheet 40. Apexes of the curves of the fluted corrugated sheet 40 may be adhered or otherwise secured to the non-gritty surface 175 of the backing sheet 170 at spaced apart locations upon the non-gritty surface 175 that correspond to the discrete locations of engagement of between the apexes of the curves of the fluted corrugated sheet 40 and the non-gritty surface 175 of the backing sheet 170. Thus, like the seal sheet 190 of this embodiment, the backing sheet 170 may also serve the functions of both a grit 180 encapsulating backing sheet 110 and a fluted corrugated sheet 40 supporting linerboard 30 (FIG. 4) such that the encapsulated grit layer 100 is sandwiched between a pair of fluted corrugated sheets 40.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention.

1. A cat scratcher comprising a scratching block that defines a depth and includes multiple encapsulated grit layers that are self-contained and extend along the depth of the scratching block and are transversely spaced from each other within the scratching block.

2. The cat scratcher of claim 1 wherein each of the encapsulated grit layers includes a backing sheet and grit particles that are bonded to the backing sheet so as to define a bonding force between the grit particles and backing sheet that is sufficiently large so that when a claw of a cat using the cat scratcher engages the encapsulated grit layer, at least one of (i) the grit particles dull, or (ii) the backing sheet tears, occurs in preference to the grit particles being released from the backing sheet.

3. The cat scratcher of claim 2 wherein each of the encapsulated grit layers includes a strip of sandpaper having a sandpaper backing sheet which defines the backing sheet of the encapsulated grit layer.

4. The cat scratcher of claim 2 wherein each of the encapsulated grit layers includes a pair of backing sheets on opposing sides of the grit particles that seal the grit particles encapsulated therebetween.

5. The cat scratcher of claim 4 wherein each of the encapsulated grit layers includes (i) a strip of sandpaper having a sandpaper backing sheet which defines a first one of the pair of backing sheets of the grit layer, and (ii) a seal sheet that abuts the strip of sandpaper and which defines a second one of the pair of backing sheets of the grit layer.

6. The cat scratcher of claim 4 wherein the scratching block includes a plurality of columns of a cardboard material and wherein each of the encapsulated grit layers is provided between a respective adjacent pair of the columns of the cardboard material.

7. The cat scratcher of claim 6 wherein each backing sheet is made from a non-cardboard material.

8. The cat scratcher of claim 7 wherein each backing sheet is made from at least one of a paper material, a cloth material, and a polymeric film material.

9. The cat scratcher of claim 6, wherein each of the encapsulated grit layers includes particles having grit sizes of between about 80 and 150 according to a CAMI (Coated Abrasive Manufacturers Institute) standard.

10. The cat scratcher of claim 9, wherein particles of the encapsulated grit layer have grit sizes of about 120 according to the CAMI standard.

11. A cat scratcher comprising a scratching block that includes multiple columns of cardboard and an encapsulated grit layer between an adjacent pair of the multiple columns of cardboard, the encapsulated grit layer including grit particles that are bonded to at least one of a backing sheet and a seal sheet that lie in opposition with respect to the grit particles so as to encapsulate the grit particles therebetween in a self-contained unit, the backing and seal sheets engaging and separating the grit particles from the pair of adjacent columns of the multiple columns of cardboard.

12. The cat scratcher of claim 11 wherein the encapsulated grit layers have a tear strength that is defined by a force required for tearing through the backing and seal sheets that is larger than a grit bonding strength that is defined by a force required to dislodge grit particles from the backing or seal sheet to which the grit particles are bonded, such that the encapsulated grit layer tears in preference to grit particle dislodging from the encapsulated grit layer.

13. The cat scratcher of claim 11 wherein a first encapsulated grit layer extends across the scratching block in a longitudinal direction.

14. The cat scratcher of claim 13 wherein a second encapsulated grit layer extends across the scratching block in a transverse direction.

15. The cat scratcher of claim 11 wherein the encapsulated grit layer extends across the scratching block in a transverse direction.

16. The cat scratcher of claim 11 wherein the encapsulated grit layer extends in a direction that is transverse with respect to a scratching direction that is defined by a direction in which a cat pulls its paws along the cat scratcher.

17. The cat scratcher of claim 11 wherein the encapsulated grit layer includes a strip of sandpaper having a sandpaper backing sheet which defines the backing sheet of the encapsulated grit layer.

18. A cat scratcher comprising a scratching block that includes a pair of cardboard columns and an encapsulated grit layer between the pair of cardboard columns, the encapsulated grit layer including a pair of sandpaper strips that have gritty surfaces that engage each other and backing sheets that engage the respective cardboard columns so that the backing sheets of the pair of sandpaper strips define barriers between the gritty surfaces of the sandpaper strips and the cardboard columns.

19. A cat scratcher comprising a scratching block that defines a longitudinal axis that is parallel to a scratching direction that is define by a direction in which a cat using the cat scratcher pulls its paws along the cat scratcher, the scratching block including encapsulated grit layers that extend transversely with respect to the longitudinal axis of the scratching block and the scratching direction.
